(19) United States
(12) Patent Application Publication
(10) Pub. No.: US 2014/0160305 A1
(43) Pub. Date: Jun. 12, 2014

(54) INFORMATION PROCESSING APPARATUS, INFORMATION PROCESSING METHOD, OUTPUT APPARATUS, OUTPUT METHOD, PROGRAM, AND INFORMATION PROCESSING SYSTEM

(71) Applicant: Sony Corporation, Minato-ku (JP)

(72) Inventor: Sawako KIRIYAMA, Kanagawa (JP)

(73) Assignee: Sony Corporation, Minato-ku (JP)

(21) Appl. No.: 14/093,132

(22) Filed: Nov. 29, 2013

(30) Foreign Application Priority Data
Dec. 6, 2012 (JP) 2012-267440

(51) Int. Cl. H04N 5/445

(52) U.S. Cl. CPC H04N 5/445
USPC 348/207.1; 348/569

(57) ABSTRACT

An information processing apparatus includes a generation unit and a transmission unit. The generation unit is configured to generate attribute information of OSD information which is displayed with the OSD information overlapped with an image, the attribute information including at least information relating to a display position and a display size of the OSD information. The transmission unit is configured to transmit the attribute information to an output apparatus that obtains display data to be used to display the OSD information corresponding to a resolution of a display unit thereof and causes the OSD information to be displayed on a position on the display unit specified by the information relating to the display position in a size specified by the information relating to the display size on the basis of the display data.

### CROSS REFERENCE TO RELATED APPLICATIONS

This application claims the benefit of Japanese Priority Patent Application JP 2012-267440 filed Dec. 6, 2012, the entire contents of which are incorporated herein by reference.

### BACKGROUND

The present disclosure relates to an information processing apparatus, an information processing method, an output apparatus, an output method, a program, and an information processing system, and particularly, to an information processing apparatus, an information processing method, an output apparatus, an output method, a program, and an information processing system capable of preventing an image quality of information displayed in an OSD form from deteriorating regardless of a resolution of a display unit of an output apparatus.

Generally, apparatuses such as a digital still camera and a digital video camera are each provided with a display panel such as an LDC (liquid crystal display). A user can view a taken image content on a display panel. When a taken image content such as a still image and a moving image is viewed, in addition to the taken image content, information relating to the taken image content and information relating to icons for operating an image taking apparatus are also displayed on the display panel.

Here, the content is a natural image displayed on the basis of a video signal obtained by an image pickup element. In contrast, the various pieces of information are artificial images such as graphics and characters generated by a computer or the like. The artificial images are displayed so as to be overlapped with the natural image in the OSD (on-screen display) form.

Further, it is common that an image taking apparatus is connected to an external output apparatus such as a TV, and a taken image content is displayed on the external output apparatus and viewed. A taken image content is output from an image taking apparatus to an external output apparatus by using a line output provided to the image taking apparatus, for example. At a time when a taken image content is subjected to a line output, an image taking apparatus scales up an artificial image on an OSD layer so that the image can be displayed on an external output apparatus, and synthesizes the image with a natural image to output the image as a video signal.

In a memory in an image taking apparatus, as display data of an artificial image to be displayed in the OSD form, data in an image size corresponding to a resolution of a display panel provided to the image taking apparatus is prepared. Generally, the resolution of a display panel of an image taking apparatus is a resolution which attains the same level as VGA (video graphics array) or SVGA (super VGA). Therefore, in the case where an artificial image prepared in a memory in an image taking apparatus is scaled up, an OSD layer is generated, and a line output thereof is performed to an external output apparatus having a display panel at a high resolution such as Full HD, the quality of the artificial image deteriorates on the external output apparatus.

In view of this, various technologies which make it possible to display a natural, vivid OSD even when a scale-up is performed have been proposed. For example, Japanese Patent Application Laid-open No. 2009-194425 discloses such a technology that, when an OSD layer is scaled up, an area where character and graphics data is disposed is scaled up in multiples of an integral, and an area where the data is not disposed is scaled up in multiples of a real number.

### SUMMARY

As long as a scale-up process is performed, image quality deterioration of an artificial image is inevitable by a technology in related art. These days, there is a TV having a display panel at a high resolution such as a QFHD (quad full HD) (3840*2160 pixels). However, in the case where the line output is performed to such a TV, if an image size of an artificial image is VGA (640*480 pixels), the artificial image has to be increased six-fold approximately. Further, in the case where an aspect ratio of a display panel provided to an image taking apparatus is different from an aspect ratio of the TV, an artificial image, the aspect ratio of which is distorted, is displayed.

In view of the above-mentioned circumstances, it is desirable to provide a technology that can prevent the image quality of information displayed in the OSD form from deteriorating regardless of a resolution of a display unit of an output apparatus.

According to a first embodiment of the present disclosure, there is provided an information processing apparatus including a generation unit and a transmission unit. The generation unit is configured to generate attribute information of OSD information which is displayed with the OSD information overlapped with an image, the attribute information including at least information relating to a display position and a display size of the OSD information. The transmission unit is configured to transmit the attribute information to an output apparatus that obtains display data to be used to display the OSD information corresponding to a resolution of a display unit thereof and causes the OSD information to be displayed on a position on the display unit specified by the information relating to the display position in a size specified by the information relating to the display size on the basis of the display data.

The information processing apparatus may further include an image taking unit configured to take the image. In this case, the transmission unit may transmit the image taken by the image taking unit and transmit the attribute information of the OSD information to be displayed with the OSD information overlapped with the image transmitted.

The generation unit may generate the attribute information further including an address of a server that manages a plurality of pieces of display data to be used to display the OSD information at different resolutions as the display data of the OSD information of the same type.

The information processing apparatus may further include a storage unit configured to store a plurality of pieces of display data to be used to display the OSD information at different resolutions as the display data of the OSD information of the same type. In this case, the transmission unit may transmit the display data to be used to display the OSD information corresponding to the resolution of the display unit of the output apparatus to the output apparatus.

The generation unit may generate the attribute information further including identification information that indicates a type of the OSD information.

According to a second embodiment of the present disclosure, there is provided an output apparatus including a display unit, a reception unit, an obtaining unit, and a display control unit. The display unit is configured to display an image. The reception unit is configured to receive attribute information of OSD information which is transmitted from an information processing apparatus that generates the attribute information, the OSD information being displayed with the OSD information overlapped with the image, the attribute information including at least information relating to a display position and a display size of the OSD information. The obtaining unit is configured to obtain display data to be used to display the OSD information corresponding to a resolution of the display unit. The display control unit is configured to cause the OSD information to be displayed on a position on the display unit specified by the information relating to the display position in a size specified by the information relating to the display size on the basis of the display data.

The reception unit may receive the image, which is taken by the information processing apparatus and transmitted from the information processing apparatus, and receive the attribute information of the OSD information to be displayed with the OSD information overlapped with the image received.

The reception unit may receive the attribute information further including an address of a server that manages a plurality of pieces of display data to be used to display the OSD information at different resolutions as the display data of the OSD information of the same type. The obtaining unit may access the server on the basis of the address and obtain the display data to be used to display the OSD information corresponding to the resolution of the display unit.

The obtaining unit may obtain, as the display data of the OSD information of the same kind, the display data to be used to display the OSD information corresponding to the resolution of the display unit from the information processing apparatus that manages a plurality of pieces of display data to be used to display the OSD information at different resolutions.

The output apparatus may further include a storage unit configured to store the display data to be used to display the OSD information corresponding to the resolution of the display unit. In this case, the reception unit may receive the attribute information further including identification information that indicates a type of the OSD information, and the obtaining unit may obtain the display data to be used to display the OSD information of the same type as a type indicated by the identification information from the storage unit.

According to a third embodiment of the present disclosure, there is provided an information processing system including an information processing apparatus and an output apparatus. The information processing apparatus includes a generation unit and a transmission unit. The generation unit is configured to generate attribute information of OSD information displayed with the OSD information overlapped with an image, the attribute information including at least information relating to a display position and a display size of the OSD information. The transmission unit is configured to transmit the attribute information to the output apparatus. The output apparatus includes a display unit, a reception unit, an obtaining unit, and a display control unit. The display unit is configured to display the image. The reception unit is configured to receive the attribute information. The obtaining unit is configured to obtain display data to be used to display the OSD information corresponding to a resolution of the display unit. The display control unit is configured to cause the OSD information to be displayed on a position on the display unit specified by the information relating to the display position in a size specified by the information relating to the display size on the basis of the display data.

In the first embodiment of the present disclosure, the attribute information of the OSD information is generated which includes at least information relating to the display position and the display size of the OSD information displayed with the OSD information overlapped with the image. The attribute information is transmitted to the output apparatus that obtains display data to be used to display the OSD information corresponding to the resolution of the display unit thereof and causes the OSD information to be displayed on a position on the display unit specified by the information relating to the display position in a size specified by the information relating to the display size on the basis of the display data.

In the second embodiment of the present disclosure, the attribute information of the OSD information is received which is transmitted from the information processing apparatus that generates the attribute information, the OSD information being displayed with the OSD information overlapped with the image, the attribute information including at least information relating to the display position and the display size of the OSD information. The display data to be used to display the OSD information corresponding to the resolution of the display unit is obtained. Further, the OSD information is caused to be displayed on the position on the display unit specified by the information relating to the display position in the size specified by the information relating to the display size on the basis of the display data.

In the third embodiment of the present disclosure, the information processing apparatus generates the attribute information of the OSD information including least the information relating to the display position and the display size of the OSD information displayed so as to be overlapped with an image, and the attribute information is transmitted to the output apparatus that obtains the display data to be used to display the OSD information corresponding to the resolution of the display unit thereof and causes the OSD information to be displayed on the position on the display unit specified by the information relating to the display position in the size specified by the information relating to the display size on the basis of the display data. Further, the output unit receives the attribute information, obtains display data to be used to display the OSD information corresponding to the resolution of the display unit, and causes the OSD information to be displayed on the position on the display unit specified by the information relating to the display position in the size specified by the information relating to the display size on the basis of the display data.

According to the embodiments of the present disclosure, it is possible to prevent the image quality of the information displayed in the OSD form from deteriorating irrespective of the resolution of the display unit of the output apparatus.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing an example of the structure of an information processing system according to an embodiment of the present disclosure;

FIG. 2 is a diagram showing a display example of a display panel of an image taking apparatus;

FIG. 3 is a block diagram showing an example of a hardware structure of the image taking apparatus;

FIG. 4 is a block diagram showing an example of a functional structure of the image taking apparatus;

FIG. 5 is a block diagram showing an example of a hardware structure of an external output apparatus;

FIG. 6 is a block diagram showing an example of a functional structure of the external output apparatus;

FIG. 7 is a flowchart for explaining a process of the image taking apparatus that outputs a taken image content;

FIG. 8 is a diagram for explaining a specific example of OSD metadata;

FIG. 9 is a diagram for explaining another specific example of the OSD metadata;

FIG. 10 is a flowchart for explaining a process of the external output apparatus that displays the taken image content;

FIG. 11 is a flowchart for explaining an OSD display data obtaining process 1 performed in Step S15 shown in FIG. 10;

FIG. 12 is a diagram showing an example of the OSD display data managed by a management server;

FIG. 13 is a flowchart for explaining an OSD display data obtaining process 2 performed in Step S16 shown in FIG. 10;

FIG. 14 is a flowchart for explaining a process of the image taking apparatus performed in association with the process of FIG. 13;

FIG. 15 is a flowchart for explaining an OSD display data obtaining process 3 performed in Step S17 shown in FIG. 10;

FIG. 16 is a diagram showing an example of the OSD information displayed on a display panel of the external output apparatus;

FIGS. 17A and 17B are diagrams for explaining the size of the OSD information;

FIG. 18 is a diagram for explaining another specific example of the OSD metadata; and

FIG. 19 is a flowchart for explaining another process of the external output apparatus that displays the taken image content.

### DETAILED DESCRIPTION OF EMBODIMENTS

<About Information Processing System>

(Structure of Information Processing System)

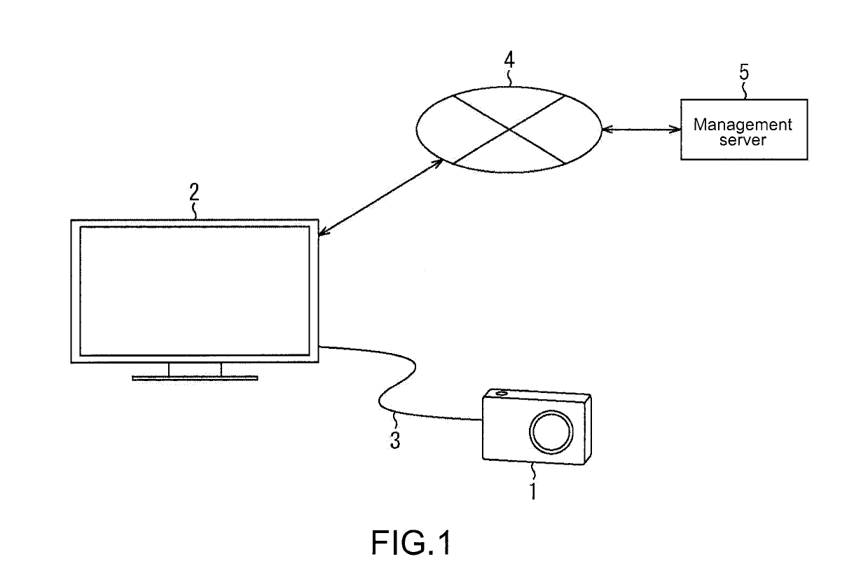

FIG. 1 is a diagram showing an example of the structure of an information processing system according to an embodiment of the present disclosure.

An information processing system shown in FIG. 1 is constituted of an image taking apparatus 1, an external output apparatus 2, and a management server 5.

The image taking apparatus 1 and the external output apparatus 2 are connected to each other via a cable 3, which is a communication cable of a predetermined standard such as an HDMI (high definition multimedia interface) and a USB (universal serial bus). The image taking apparatus 1 and the external output apparatus 2 may be connected to each other through wireless communication such as a wireless LAN and Bluetooth (registered trademark). The external output apparatus 2 and the management server 5 are each connected to an Internet 4 and can transmit and receive data to and from each other via the Internet 4.

The image taking apparatus 1 is an apparatus having an image taking function, such as a digital still camera and a digital video camera. A user can take an image with the use of the image taking apparatus 1 and cause a taken image content such as a still image and a moving image, which is a natural image stored in a memory in the image taking apparatus 1, to be displayed on a display panel provided on a back surface of the image taking apparatus 1 to view the content. When the taken image content is viewed, artificial images of various buttons used for a reproduction operation and information or the like relating to the taken image content are displayed in the OSD form with the artificial images overlapped with the taken image content.

In the image taking apparatus 1, OSD display data, which is data to be used to display OSD information as information such as images and characters displayed in the OSD form, is prepared in advance. The OSD display data prepared in the image taking apparatus 1 corresponds to a resolution of the display panel of the image taking apparatus 1, for example.

The external output apparatus 2 is an apparatus such as a TV having a display panel. The display panel of the external output apparatus 2 is a display panel, such as a full HD (1920*1080 pixels), having a higher resolution than the display panel of the image taking apparatus 1.

The management server 5 manages the OSD display data and transmits the data to the external output apparatus 2 via the Internet 4 when necessary.

In the information processing system having the structure as described above, the user can cause the taken image content in the image taking apparatus 1 to be displayed on the display panel of the external output apparatus 2.

For example, in the case where the user gives an instruction to output the taken image content to the external output apparatus, the image taking apparatus 1 reads the taken image content from the memory and outputs the content to the external output apparatus 2 via the cable 3.

Further, the image taking apparatus 1 causes the OSD information, which is displayed in the overlapped manner with the taken image content, to be metadata. The image taking apparatus 1 transmits OSD metadata, which is the OSD information made to be metadata, to the external output apparatus 2. The OSD metadata may be transmitted via the cable 3 or wirelessly. In the case where the cable 3 is an analog cable capable of performing a line output, the taken image content is transmitted by the line output, and the OSD metadata is transmitted by using a USB cable (not shown) different from the cable 3 or the wireless communication.

As will be described later, the OSD metadata, which is attribute information of the OSD information, includes information that indicates a display position and a size in addition to identification information of each piece of OSD information.

On the other hand, the external output apparatus 2 receives the taken image content transmitted from the image taking apparatus 1 and causes the content to be displayed on the display panel thereof. Further, the external output apparatus 2 obtains OSD display data on the basis of the OSD metadata transmitted from the image taking apparatus 1 and causes the OSD information to be displayed so as to be overlapped with the taken image content. The OSD display data obtained by the external output apparatus 2 corresponds to the resolution of the display panel of the external output apparatus 2 and is used to display OSD information at a higher resolution than the OSD information displayed on the image taking apparatus 1.

As described above, in the information processing system shown in FIG. 1, when the taken image content in the image taking apparatus 1 is displayed on the external output apparatus 2, the OSD information is not transmitted in the state of being overlapped with the taken image content but transmitted in the metadata state from the image taking apparatus 1 to the external output apparatus 2. Further, in the external output apparatus 2 that receives the OSD metadata, the OSD display data corresponding to the resolution of the display panel of the external output apparatus 2 is obtained and used to display the OSD information.

As a result, the OSD information is output from the image taking apparatus 1 as a video signal in the state of being overlapped with the taken image content. It is possible to prevent the image quality of the OSD information from deteriorating, as compared to the case where the OSD information is displayed as it is on the display panel of the external output apparatus 2.

That is, the OSD display data prepared in the image taking apparatus 1 corresponds to the resolution of the display panel of the image taking apparatus 1. In the case where the OSD display data is used as it is, and the OSD information is displayed on the display panel of the external output apparatus 2 at a high resolution, the OSD information is expanded, resulting in the deterioration of the image quality thereof. To display the OSD information, the OSD display data prepared in the image taking apparatus 1 is not used, but the OSD display data corresponding to the resolution of the display panel of the external output apparatus 2 is used, with the result that the deterioration of the image quality can be prevented.

(Method of Obtaining OSD Display Data)

There are three methods of obtaining the OSD display data by the external output apparatus 2 as follows.

(1) Method of Obtaining OSD Display Data from Management Server 5

In the management server 5, the OSD display data to be used to display the pieces of OSD information at various resolutions is prepared. The information displayed as the OSD information includes a plurality of pieces of information such as an image of a reproduction button, an image of an end button, and the like. For each type of the OSD information, OSD display data to be used to display the OSD information with the various resolutions.

The external output apparatus 2 accesses the management server 5 on the basis of the OSD metadata transmitted from the image taking apparatus 1. The OSD metadata includes an address of the management server 5 from which the OSD display data is obtained.

In addition, the external output apparatus 2 downloads and obtains, from the management server 5, OSD display data to be used to display OSD information, which is OSD information of a type specified to be displayed in the overlapped manner with the taken image content and has a resolution that allows to be displayed on the external output apparatus 2. On the basis of the OSD display data obtained from the management server 5, the external output apparatus 2 causes the OSD information to be displayed so as to be overlapped with the taken image content transmitted from the image taking apparatus 1.

(2) Method of Obtaining OSD Display Data from Image Taking Apparatus 1

In this case, in the memory of the image taking apparatus 1, the OSD display data to be used to display the OSD information with the various resolutions is prepared. That is, for each type of the pieces of OSD information, the OSD display data to be used to display the OSD information at the various resolutions is prepared in the image taking apparatus 1.

On the basis of OSD metadata transmitted from the image taking apparatus 1, the external output apparatus 2 determines a type of the OSD information specified to be displayed and obtains the OSD display data to be used to display the OSD information at a resolution that allows to be displayed on the external output apparatus 2 from the image taking apparatus 1.

The OSD display data may be obtained from the image taking apparatus 1 by using the same communication channel as that used for the transmission and reception of the taken image content or by using a different communication channel therefrom. On the basis of the OSD display data obtained from the image taking apparatus 1, the external output apparatus 2 causes the OSD information to be displayed in the overlapped manner with the taken image content transmitted from the image taking apparatus 1.

(3) Method of Obtaining OSD Display Data from External Output Apparatus 2

In this case, in the memory in the external output apparatus 2, the OSD display data to be used to display the OSD information corresponding to the resolution of the display panel of the external output apparatus 2 is prepared. For example, if the external output apparatus 2 has the display panel with the full HD resolution, in the memory in the external output apparatus 2, for each type of pieces of OSD information, the OSD display data to be used to display the OSD information corresponding to the full HD is prepared.

On the basis of the OSD metadata transmitted from the image taking apparatus 1, the external output apparatus 2 determines the OSD information of the type specified to be displayed in the overlapped manner with the taken image content and reads the OSD display data to be used to display the OSD information of the same type from the memory therein. The OSD metadata transmitted from the image taking apparatus 1 includes an ID that indicates the type (meaning) of the OSD information. On the basis of the OSD display data read from the memory, the external output apparatus 2 causes the OSD information to be displayed so as to be overlapped with the taken image content transmitted from the image taking apparatus 1. As a result, the OSD information which the image taking apparatus 1 tries to display is replaced by the OSD information prepared in the external output apparatus 2.

The obtaining of the OSD display data by the external output apparatus 2 is carried out as described above. The obtaining methods will be described below in detail with reference to flowcharts.

(Example of OSD Information)

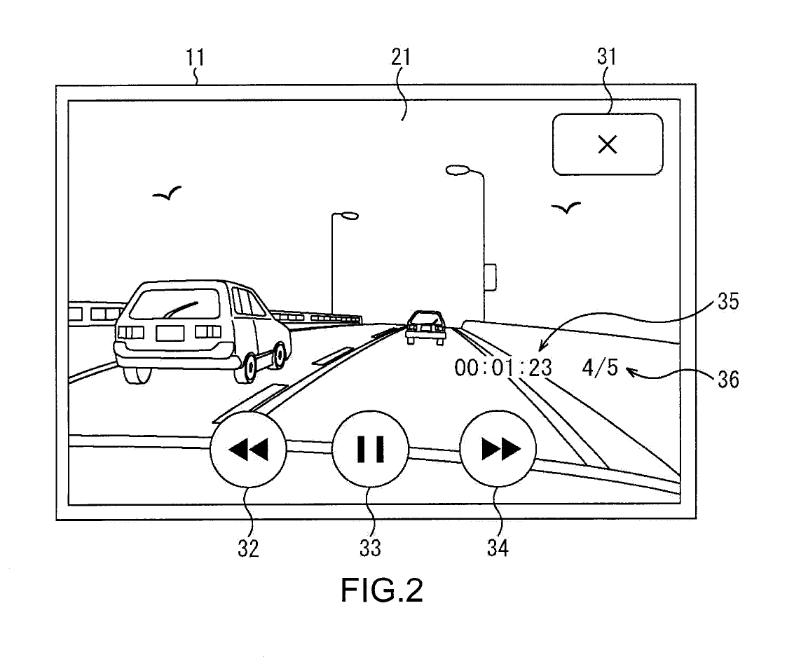

FIG. 2 is a diagram showing a display example of the display panel of the image taking apparatus 1. When an instruction to display the taken image content is given, on a display panel 11 provided on the back surface of the image taking apparatus 1, a screen as shown in FIG. 2 is displayed.

On an entire surface of the display panel 11, a taken image content display area 21 is provided, and a taken image content selected by a user is displayed. The various pieces of OSD information are displayed so as to be overlapped with the taken image content displayed on the taken image content display area 21.

On an upper right portion of the screen, a function end button 31, which is operated to end a reproduction of the taken image content, is displayed, and on the center of a lower portion of the screen, reproduction operation buttons 32, 33, and 34 are displayed so as to be aligned. The reproduction operation button 32 is used to perform a fast-rewind operation to return to a preceding taken image content, for example. The reproduction operation button 33 is operated when the reproduction of the taken image content is temporarily stopped. The reproduction operation button 34 is used to perform a fast-forward operation to the next taken image content, for example.

Above the reproduction operation button 34, a reproduction time information 35 is displayed, and on the right side of the reproduction time information 35, a file number information 36 is displayed.

In this way, in the image taking apparatus 1, image data for displaying the function end button 31 and the reproduction operation buttons 32, 33, and 34 and character data for displaying the reproduction time information 35 and the file number information 36 are prepared as the OSD display data, and the data is used when the taken image content is reproduced. The function end button 31, the reproduction operation buttons 32, 33, and 34, the reproduction time information 35, and the file number information 36 are the OSD information generated so as to be correspond to the resolution of the display panel 11.

Hereinafter, as appropriate, specific examples of the screen to be displayed on the external output apparatus 2 will be described with reference to FIG. 2.

<About Structure of Apparatus>

(Example of Structure of Image Taking Apparatus 1)

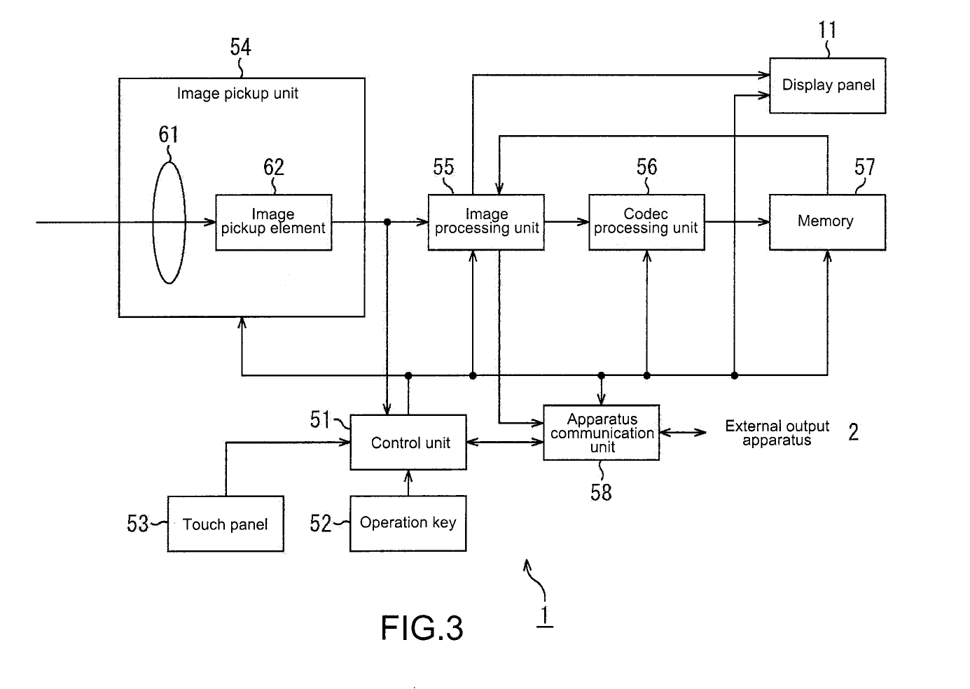

FIG. 3 is a block diagram showing an example of a hardware structure of the image taking apparatus 1.

The image taking apparatus 1 is constituted of the display panel 11, a control unit 51, an operation key 52, a touch panel 53, an image pickup unit 54, an image processing unit 55, a codec processing unit 56, a memory 57, and an apparatus communication unit 58. The image pickup unit 54 is constituted of a lens unit 61 and an image pickup element 62.

The control unit 51 includes a CPU (central processing unit), a ROM (read only memory), a RAM (random access memory), and the like. The control unit 51 executes a predetermined program and controls operations of the units of the image taking apparatus 1 in accordance with a signal supplied from the operation key 52 or the touch panel 53.

For example, in the case where the taken image content is displayed on the external output apparatus 2, the control unit 51 controls the image processing unit 55 so that the taken image content which is ordered to be reproduced is read from the memory 57 and reproduced. The control unit 51 causes video data of the taken image content obtained by the reproduction to be supplied to the apparatus communication unit 58 from the image processing unit 55 and transmitted to the external output apparatus 2. Further, the control unit 51 causes the OSD information, which is displayed so as to be overlapped with the taken image content ordered to be reproduced, to be metadata, and outputs the OSD metadata to the apparatus communication unit 58 to transmit the metadata to the external output apparatus 2.

The operation key 52 is constituted of a button provided on a back surface of a casing of the image taking apparatus 1, a shutter button provided on an upper surface thereof, and the like and outputs a signal that indicates a content of an operation by the user to the control unit 51.

The touch panel 53 is provided so as to be layered on the display panel 11 and outputs a signal that indicates a position where the user touches with a finger or the like to the control unit 51.

The lens unit 61 of the image pickup unit 54 is constituted of an image pickup optical system such as a lens and the like. The lens unit 61 is driven on the basis of the control by the control unit 51 to guide light from a subject to the image pickup element 62.

The image pickup element 62 is an image pickup element such as a CMOS (complementary metal oxide semiconductor). The image pickup element 62 performs photoelectric conversion and performs A/D conversion for a signal corresponding to an intensity of the light to output the signal to the image processing unit 55.

The image processing unit 55 performs various image processes such as a white balance adjustment process with respect to the image signal supplied from the image pickup element 62. The image processing unit 55 outputs the image signal obtained by performing the image processes to the display panel 11 and the codec processing unit 56.

In addition, when the taken image content is reproduced, the image processing unit 55 reads and reproduces the taken image content recorded in the memory 57. In the case where the taken image content is displayed on the display panel 11, the image processing unit 55 outputs the video data of the taken image content to the display panel 11. In the case where the taken image content is displayed on the external output apparatus 2, the video data of the taken image content to the apparatus communication unit 58.

The codec processing unit 56 performs a coding process with respect to the image signal from the image processing unit 55 and supplies the image data to the memory 57.

The memory 57 is a flash memory and records the image data supplied from the codec processing unit 56.

The apparatus communication unit 58 performs communication with the external output apparatus 2 via the cable 3 or wirelessly. The apparatus communication unit 58 transmits the video data of the taken image content supplied from the image processing unit 55 and the OSD metadata supplied from the control unit 51 to the external output apparatus 2.

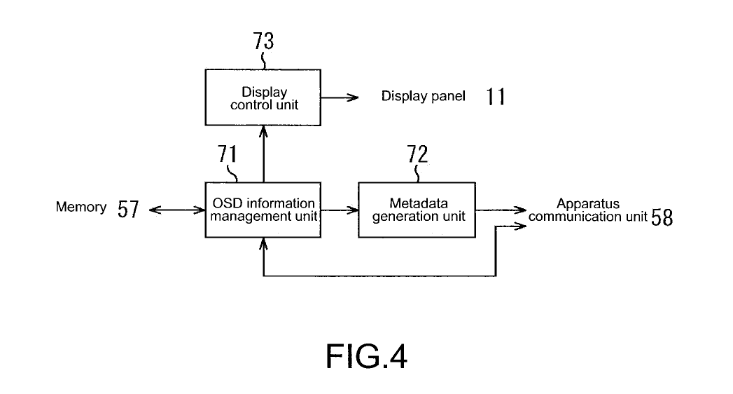

FIG. 4 is a block diagram showing an example of a functional structure of the image taking apparatus 1.

At least a part of a functional part shown in FIG. 4 is attained by executing a predetermined program by the CPU of the control unit 51 shown in FIG. 3. In the image taking apparatus 1, an OSD information management unit 71, a metadata generation unit 72, and a display control unit 73 are attained.

The OSD information management unit 71 manages the OSD display data stored in the memory 57. The OSD display data managed by the OSD information management unit 71 is used to display the OSD information corresponding to the resolution of the display panel 11. When the taken image content is displayed on the external output apparatus 2, the OSD information management unit 71 outputs information relating to a type, a position, a size, and the like of the OSD information which is displayed so as to be overlapped with the taken image content to the metadata generation unit 72.

In the case where the OSD display data is obtained by the external output apparatus 2 from the image taking apparatus 1 (case of the above item (2)), the OSD information management unit 71 manages the OSD display data to be used to display the OSD information at the various resolutions. The OSD information management unit 71 controls the apparatus communication unit 58 and causes the OSD display data requested from the external output apparatus 2 to be transmitted to the external output apparatus 2.

The metadata generation unit 72 causes the OSD information supplied from the OSD information management unit 71 to be metadata, thereby generating OSD metadata. The metadata generation unit 72 outputs the generated OSD metadata to the apparatus communication unit 58 and causes the metadata to be output to the external output apparatus 2. A specific example of the metadata will be described later.

The display control unit 73 controls a display on the display panel 11. For example, when the taken image content is displayed on the display panel 11, the display control unit 73 causes the image processing unit 55 to reproduce the taken image content. Further, the display control unit 73 displays the OSD information managed by the OSD information management unit 71 so as to be overlapped with the taken image content displayed on the display panel 11.

(Example of Structure of External Output Apparatus 2)

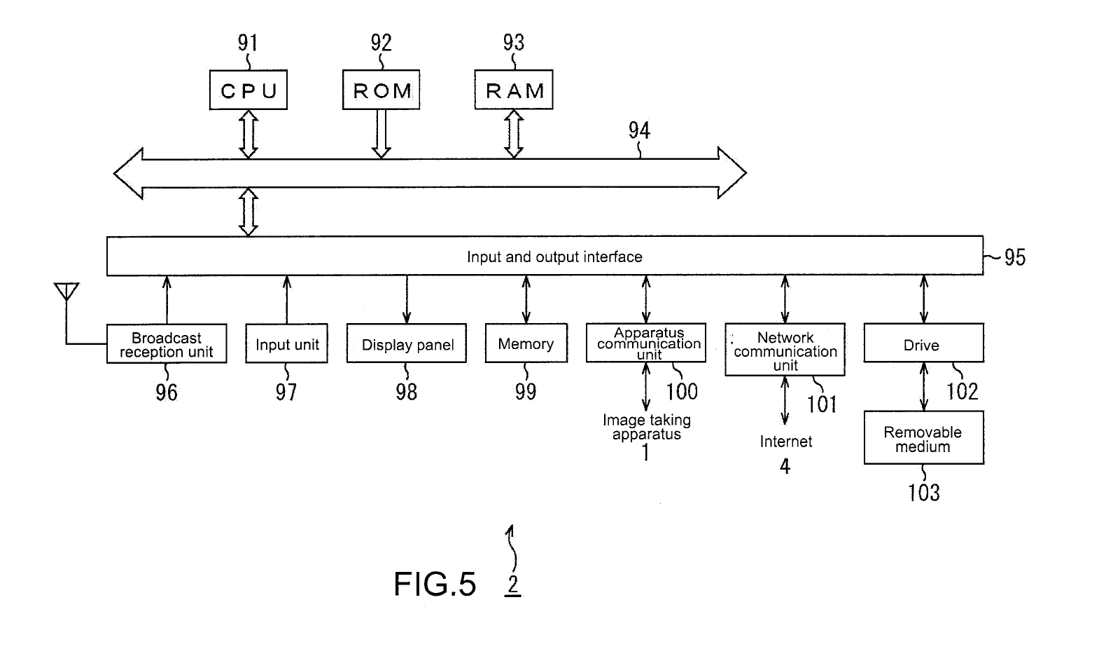

FIG. 5 is a block diagram showing an example of a hardware structure of the external output apparatus 2.

A CPU 91, a ROM 92, and a RAM 93 are connected via a bus 94. To the bus 94, an input and output interface 95 is further connected. To the input and output interface 95, a broadcast reception unit 96, an input unit 97, a display panel 98, a memory 99, an apparatus communication unit 100, a network communication unit 101, and a drive 102 are connected.

The broadcast reception unit 96 receives a broadcast signal from an antenna at a time of viewing a broadcast program and performs a demodulation process for the broadcast signal. The broadcast reception unit 96 decodes program data obtained by performing the demodulation process and outputs and displays video data of the program on the display panel 98.

The input unit 97 receives a signal from a remote controller and outputs a signal that indicates a content of an operation by the user to the CPU 91.

The display panel 98 is formed of an LCD or the like. The display panel 98 displays a video of the program received by the broadcast reception unit 96 and a taken image content transmitted from the image taking apparatus 1 and received by the apparatus communication unit 100.

The memory 99 records various pieces of information such as programs executed by the CPU 91. As described above, in the case where the OSD display data is obtained by the external output apparatus 2 from the memory thereof (case of the above item (3)), the memory 99 records the OSD display data used to display the OSD information corresponding to the resolution of the display panel 98.

The apparatus communication unit 100 performs communication with the image taking apparatus 1 via the cable 3 or wirelessly. The apparatus communication unit 100 receives the video data of the taken image content transmitted from the image taking apparatus 1 and outputs the data to the display panel 98. Further, the apparatus communication unit 100 receives the OSD metadata transmitted from the image taking apparatus 1 and outputs the metadata to the CPU 91.

The network communication unit 101 performs communication with the management server 5 via the Internet 4.

The drive 102 drives a removable medium 103 to read data recorded in the removable medium 103 and write data to the removable medium 103.

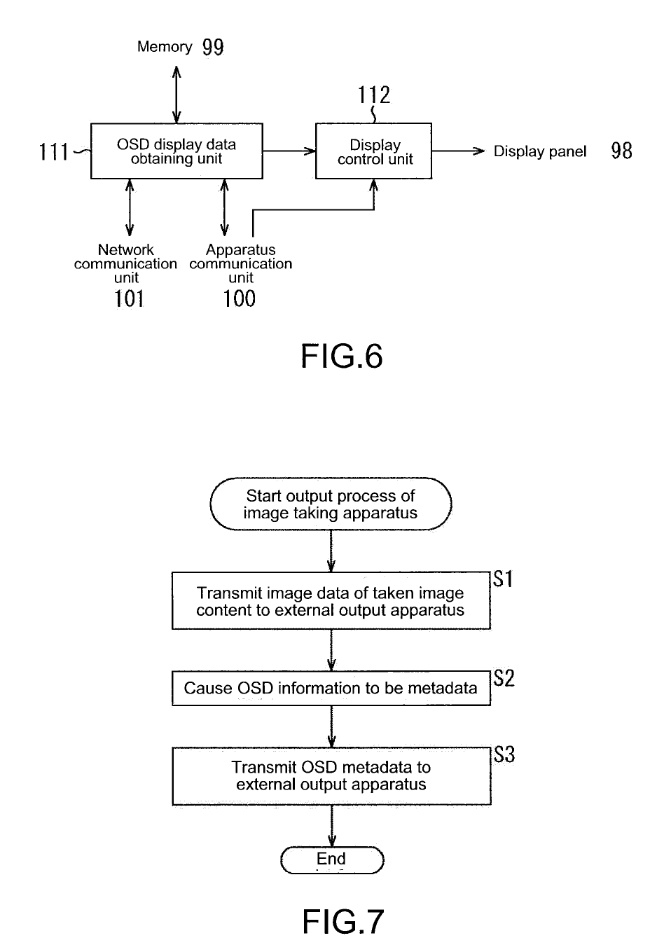

FIG. 6 is a block diagram showing an example of a functional structure of the external output apparatus 2.

At least a part of a functional part shown in FIG. 6 is attained by executing a predetermined program by the CPU 91 shown in FIG. 5. In the external output apparatus 2, an OSD display data obtaining unit 111 and a display control unit 112 are attained.

The OSD display data obtaining unit 111 obtains the OSD display data on the basis of the OSD metadata transmitted from the image taking apparatus 1 and received by the apparatus communication unit 100 and outputs the obtained OSD display data to the display control unit 112.

For example, in the case where the OSD display data is obtained from the management server 5, the ODS display data obtaining unit 111 controls the network communication unit 101 to access the management server 5. The OSD display data obtaining unit 111 requests to transmit the OSD display data to be used to display the OSD information corresponding to the resolution of the display panel 98. The OSD display data obtaining unit 111 receives and obtains the OSD display data transmitted from the management server 5 in response to the request.

In addition, in the case where the OSD display data is obtained from the image taking apparatus 1, the OSD display data obtaining unit 111 controls the apparatus communication unit 100 to access the image taking apparatus 1. The OSD display data obtaining unit 111 requests to transmit the OSD display data used to display the OSD information corresponding to the resolution of the display panel 98. The OSD display data obtaining unit 111 receives and obtains the OSD display data transmitted from the image taking apparatus 1 in response to the request.

In the case where the OSD display data from the memory in the external output apparatus 2, the OSD display data obtaining unit 111 specifies a type of the OSD information to be displayed and reads and obtains the OSD display data to be used to display the OSD information of the same type from the memory 99.

The display control unit 112 controls a display on the display panel 98. For example, on the basis of the video data transmitted from the image taking apparatus 1 and received by the apparatus communication unit 100, the display control unit 112 causes the taken image content to be displayed on the display panel 98. Further, on the basis of the OSD display data obtained by the OSD display data obtaining unit 111, the display control unit 112 displays the OSD information so as to be overlapped with the taken image content.

<About Processes of Apparatuses>

Here, processes of the image taking apparatus 1 and the external output apparatus 2 having the structures as described above will be described.

(Process of Image Taking Apparatus 1)

First, with reference to a flowchart of FIG. 7, a process of the image taking apparatus 1 to output the taken image content to the external output apparatus 2 will be described.

The process shown in FIG. 7 is started when the user connects the image taking apparatus 1 to the external output apparatus 2 and selects a taken image content to be displayed on the external output apparatus 2 by operating the touch panel 53 of the image taking apparatus 1, for example. When the taken image content is selected, the taken image content read from the memory 57 is reproduced by the image processing unit 55, and the video data of the taken image content is supplied to the apparatus communication unit 58.

In Step S1, the apparatus communication unit 58 transmits the video data of the taken image content supplied from the image processing unit 55 to the external output apparatus 2.

In Step S2, the metadata generation unit 72 causes, out of the pieces of OSD information managed by the OSD information management unit 71, the OSD information displayed so as to be overlapped with the taken image content to be metadata. The metadata generation unit 72 outputs the OSD metadata to the apparatus communication unit 58.

In Step S3, the apparatus communication unit 58 transmits the OSD metadata supplied from the metadata generation unit 72 to the external output apparatus 2. After that, the process is terminated.

(Specific Example of OSD Metadata)

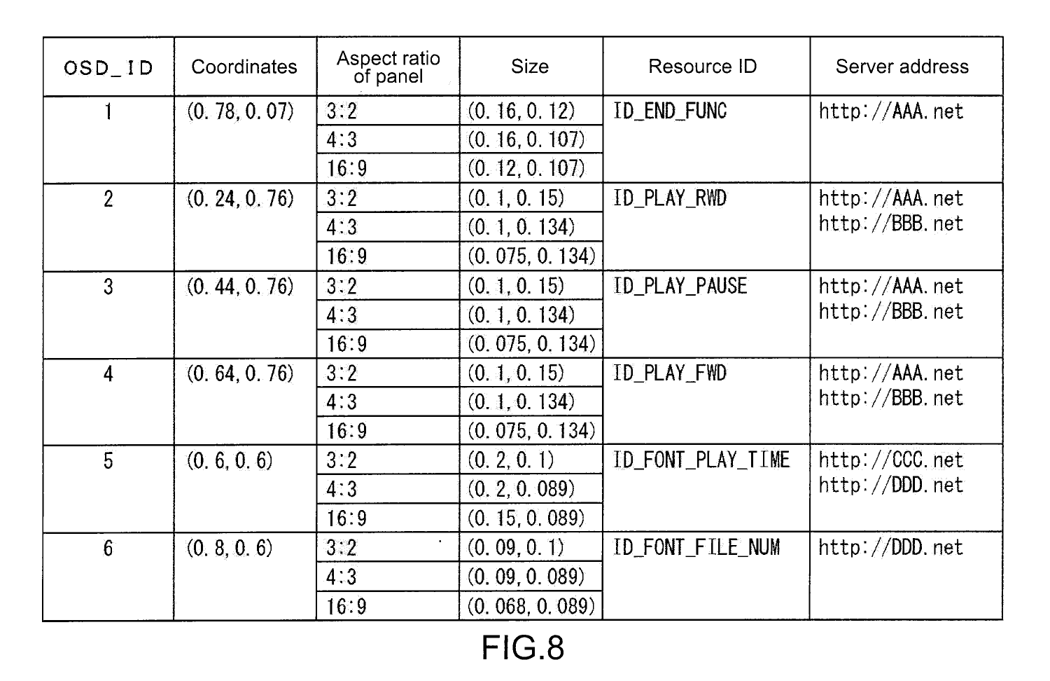

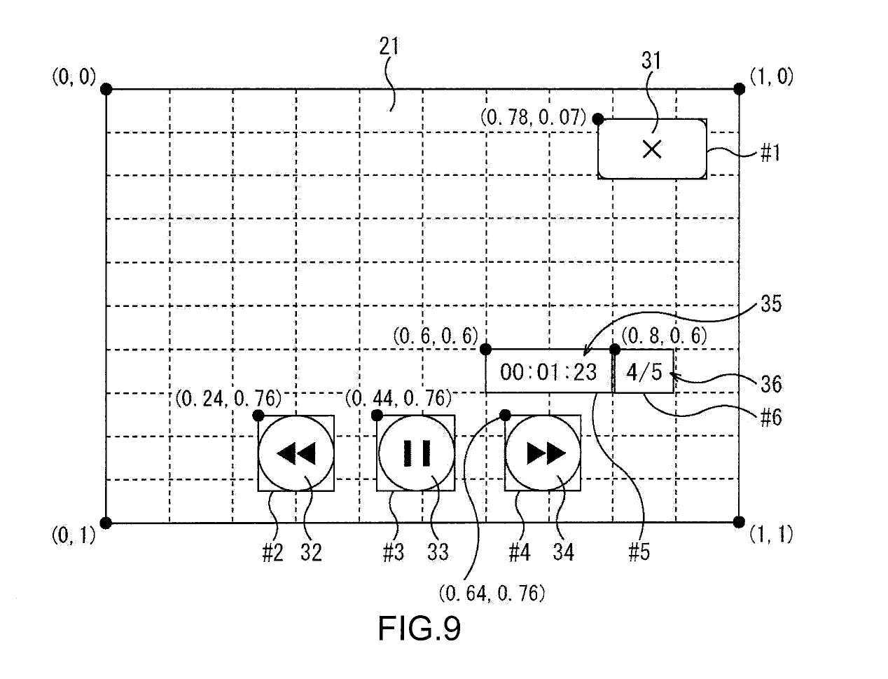

A specific example of the OSD metadata will be described with reference to FIGS. 8 and 9. As shown in FIG. 8, the OSD metadata includes OSD_IDs, coordinates, aspect ratios of the display panels, sizes, resource IDs, and addresses of servers.

The OSD_ID is identification information of the OSD information and assigned to each piece of OSD information displayed in one frame.

The coordinates represent a display position of the OSD information in an x-axis direction and a y-axis direction in a displayable area with values ranging from 0 to 1.

The aspect ratio of the display panel is an aspect ratio of the display panel on which the OSD information is to be displayed. In the example of FIG. 5, the display panel 98 of the external output apparatus 2 is a display destination of the OSD information.

The size is a size of the area of the OSD information in the x axis direction and the y axis direction by values ranging from 0 to 1 with the size of an entire displayable area of the OSD information being set as 1. The size is prepared for each aspect ratio of the display panel.

The resource ID is identification information that indicates the type of the OSD information.

The server address indicates a URL of a server from which the OSD information is to be obtained, when the OSD information is obtained from the server on the Internet 4.

The OSD metadata shown in FIG. 8 is data obtained by causing the function end button 31, the reproduction operation buttons 32 to 34, the reproduction time information 35, and the file number information 36 shown in FIG. 2 as the OSD information to be metadata. To the function end button 31, the reproduction operation buttons 32 to 34, the reproduction time information 35, and the file number information 36, 1 to 6 are allocated, respectively, as the OSD_IDs.

That is, in FIG. 8, the pieces of information associated with the OSD_ID=1 are the metadata of the function end button 31. The pieces of information associated with the OSD_ID=2 are the metadata of the reproduction operation button 32. The pieces of information associated with the OSD_ID=3 are the metadata of the reproduction operation button 33. The pieces of information associated with the OSD_ID=4 are the metadata of the reproduction operation button 34. The pieces of information associated with the OSD_ID-5 are the metadata of the reproduction time information 35. The pieces of information associated with the OSD_ID=6 are the metadata of the file number information 36.

As shown in FIG. 9, an upper left end of the display panel 11 as the displayable area of the OSD information is set as an origin point (0, 0). An upper right end, a lower left end, and a lower right end are expressed by positions (1, 0), (0, 1), and (1, 1), respectively. The function end button 31, the reproduction operation buttons 32 to 34, the reproduction time information 35, and the file number information 36 are displayed in areas #1 to #6 as rectangular areas, respectively.

The position of the area #1 is represented as (0.78, 0.07), and the size thereof is represented as (0.16, 0.12) if the aspect ratio of the display panel 11 of the image taking apparatus 1 is 3:2. In this case, as shown in FIG. 8, the coordinates of the function end button 31 as the OSD information of OSD_ID=1 are (0.78, 0.07), and the size thereof is (0.16, 0.12) on the display panel having the aspect ratio of 3:2. In addition, the size thereof is (0.16, 0.107) on the display panel having the aspect ratio of 4:3 and (0.12, 0.107) on the display panel having the aspect ratio of 16:9. As the resource ID, “ID_END_FUNC” is allocated, and as the address of the server, “http://AAA.net” is set. The “http://AAA.net” is the address of the management server 5.

The position of the area #2 is represented as (0.24, 0.76), and the size thereof is represented as (0.1, 0.15) if the aspect ratio of the display panel 11 of the image taking apparatus 1 is 3:2. In this case, as shown in FIG. 8, the coordinates of the reproduction operation button 32 as the OSD information of OSD_ID=2 are (0.24, 0.76), and the size thereof is (0.1, 0.15) on the display panel having the aspect ratio of 3:2. In addition, the size thereof is (0.1, 0.134) on the display panel having the aspect ratio of 4:3 and (0.075, 0.134) on the display panel having the aspect ratio of 16:9. As the resource ID, “ID_PLAY_RWD” is allocated. To the address of the server, the “http://AAA.net” and “http://BBB.net” as the address of another server are set. In this way, it is also possible to set a plurality of URLs as the source from which one piece of OSD information is obtained.

The position of the area #3 is represented as (0.44, 0.76), and the size thereof is represented as (0.1, 0.15) if the aspect ratio of the display panel 11 of the image taking apparatus 1 is 3:2. In this case, as shown in FIG. 8, the coordinates of the reproduction operation button 33 as the OSD information of OSD_ID=3 are (0.44, 0.76), and the size thereof is (0.1, 0.15) on the display panel having the aspect ratio of 3:2. In addition, the size thereof is (0.1, 0.134) on the display panel having the aspect ratio of 4:3 and (0.075, 0.134) on the display panel having the aspect ratio of 16:9. As the resource ID, “ID_PLAY_PAUSE” is allocated. To the address of the server, the “http://AAA.net” and the “http://BBB.net” are set.

The position of the area #4 is represented as (0.64, 0.76), and the size thereof is represented as (0.1, 0.15) if the aspect ratio of the display panel 11 of the image taking apparatus 1 is 3:2. In this case, as shown in FIG. 8, the coordinates of the reproduction operation button 34 as the OSD information of OSD_ID=4 are (0.64, 0.76), and the size thereof is (0.1, 0.15) on the display panel having the aspect ratio of 3:2. In addition, the size thereof is (0.1, 0.134) on the display panel having the aspect ratio of 4:3 and (0.075, 0.134) on the display panel having the aspect ratio of 16:9. As the resource ID, “ID_PLAY_FWD” is allocated. To the address of the server, the “http://AAA.net” and the “http://BBB.net” are set.

The position of the area #5 is represented as (0.6, 0.6), and the size thereof is represented as (0.2, 0.1) if the aspect ratio of the display panel 11 of the image taking apparatus 1 is 3:2. In this case, as shown in FIG. 8, the coordinates of the reproduction time information 35 as the OSD information of OSD_ID=5 are (0.6, 0.6), and the size thereof is (0.2, 0.1) on the display panel having the aspect ratio of 3:2. In addition, the size thereof is (0.2, 0.089) on the display panel having the aspect ratio of 4:3 and (0.15, 0.089) on the display panel having the aspect ratio of 16:9. As the resource ID, “ID_FONT_PLAY_TIME” is allocated. To the address of the server, “http://CCC.net” and “http://DDD.net” are set.

The position of the area #6 is represented as (0.8, 0.6), and the size thereof is represented as (0.09, 0.1) if the aspect ratio of the display panel 11 of the image taking apparatus 1 is 3:2. In this case, as shown in FIG. 8, the coordinates of the file number information 36 as the OSD information of OSD_ID=6 are (0.8, 0.6), and the size thereof is (0.09, 0.1) on the display panel having the aspect ratio of 3:2. In addition, the size thereof is (0.09, 0.089) on the display panel having the aspect ratio of 4:3 and (0.068, 0.089) on the display panel having the aspect ratio of 16:9. As the resource ID, “ID_FONT_FILE_NUM” is allocated. To the address of the server, the “http://DDD.net” is set.

As described above, the pieces of OSD information are caused to be metadata and transmitted to the external output apparatus 2. To transmit the OSD metadata, various communication means such as USB communication and wireless LAN communication can be used. Further, to represent the OSD metadata, a method of using a markup language such as HTML and XML or various other methods can be used.

By representing the display positions of the pieces of OSD information by using normalized values with the entire display panel of the image taking apparatus 1 as the reference, it is possible to maintain the positional relationship among the pieces of OSD information irrespective of the aspect ratio or the size of the display panel 98 of the external output apparatus 2. Further, by preparing the size of the OSD information for each aspect ratio and causing the external output apparatus 2 to elect the size corresponding to the aspect ratio of the display panel 98, it is possible to maintain the relationship among the size of the pieces of OSD information irrespective of the aspect ratio of the display panel 98.

(Process of External Output Apparatus 2)

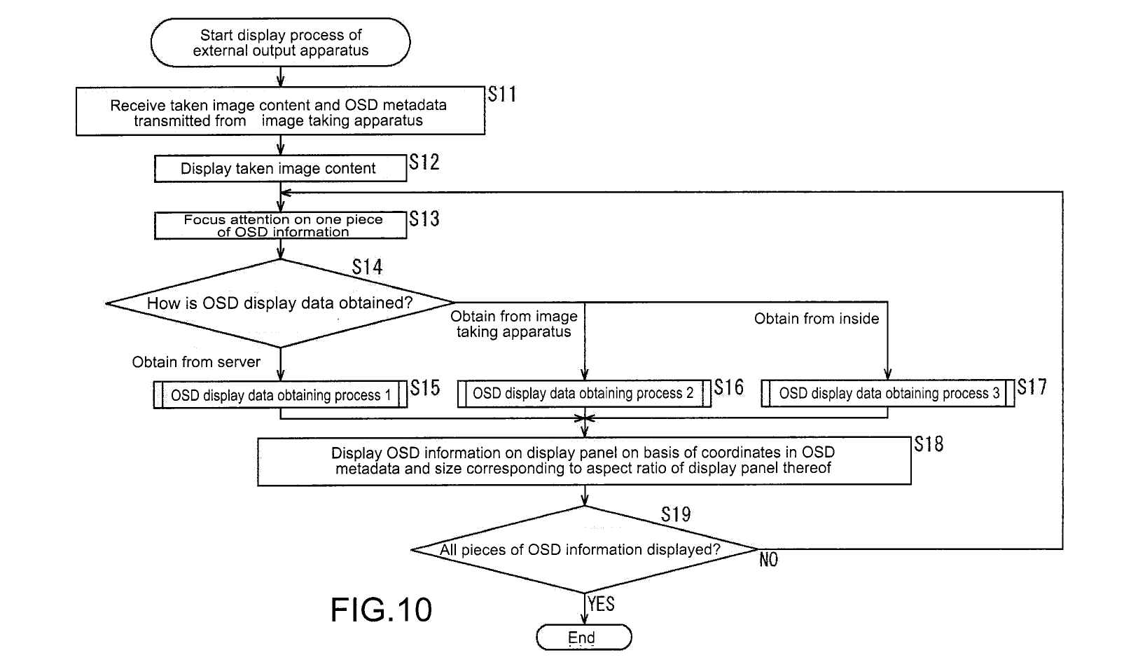

Next, with reference to a flowchart of FIG. 10, a process of the external output apparatus 2 that displays the taken image content will be described.

In Step S11, the apparatus communication unit 100 receives the taken image content and the OSD metadata transmitted from the image taking apparatus 1. The taken image content received by the apparatus communication unit 100 is supplied to the display control unit 112, and the OSD metadata is supplied to the OSD display data obtaining unit 111.

In Step S12, the display control unit 112 causes the taken image content to be displayed on the display panel 98.

In Step S13, the OSD display data obtaining unit 111 focuses attention on one piece of OSD information. For example, as shown in FIG. 8, in the case where the plurality of pieces of OSD information are specified as the OSD information to be displayed in one frame, the pieces of OSD information receive attention in ascending order of OSD_IDs.

In Step S14, the OSD display data obtaining unit 111 determines the obtaining method for the OSD display data to be used to display the OSD information on which attention is focused.

In the case where it is determined that the OSD display data is obtained from the management server 5 in Step S14, the OSD display data obtaining unit 111 performs an OSD display data obtaining process 1 in Step S15. The OSD display data obtaining process 1 is a process of obtaining the OSD display data from the management server 5.

On the other hand, in the case where it is determined that the OSD display data is obtained from the image taking apparatus 1 in Step S14, the OSD display data obtaining unit 111 performs an OSD display data obtaining process 2 in Step S16. The OSD display data obtaining process 2 is a process of obtaining the OSD display data from the image taking apparatus 1.

In the case where it is determined that the OSD display data is obtained from the memory in the external output apparatus 2 in Step S14, the OSD display data obtaining unit 111 performs an OSD display data obtaining process 3 in Step S17. The OSD display data obtaining process 3 is a process of obtaining the OSD display data from the memory 99 of the external output apparatus 2.

The display data of all the pieces of OSD information may be obtained by the same process or by different processes. The determination of Step S14 is performed on the basis of a setting by a user, for example. Instead of the setting of the obtaining method by the user, the determination may be performed on the basis of a priority order automatically set by the external output apparatus 2.

The details of the OSD display data obtaining processes 1 to 3 will be described below. The OSD display data obtained by the OSD display data obtaining processes 1 to 3 is supplied to the display control unit 112.

In Step S18, on the basis of the size corresponding to the aspect ratio of the display panel 98 and the coordinates included in the OSD metadata, the display control unit 112 causes the OSD information on which attention is focused to be displayed on the display panel 98. That is, on the basis of the OSD display data, the display control unit 112 causes the OSD information which has a size specified by the size corresponding to the aspect ratio of the display panel 98 and is included in the OSD metadata to be displayed on the position on the display panel 98 specified by the coordinates included in the OSD metadata with the OSD information overlapped with the taken image content.

For example, to display the OSD information of OSD_ID=1 shown in FIG. 8 will be described. The assumption is made that the resolution of the display panel 98 of the external output apparatus 2 is 1920*1080 pixels. The display position of the OSD information on the display panel 98 on the basis of the obtained OSD display data is a position represented by (1920*0.78, 1080*0.07)=(1497, 75). For the size of the OSD information on the display panel 98, (0.12, 0.107) corresponding to 16:9, which is the aspect ratio of the display panel 98, is selected, and a size represented by (1920*0.12, 1080*0.107)=(230, 116) is determined.

In Step S19, the display control unit 112 determines whether displaying all the pieces of OSD information specified is terminated or not.

In the case where it is determined that displaying all the pieces of OSD information is not terminated in Step S19, the process returns to Step S13. The next piece of OSD information receives attention, and the process described above is repeated. On the other hand, when it is determined that displaying all the pieces of OSD information is terminated in Step S19, the process is terminated.

(OSD Display Data Obtaining Process 1)

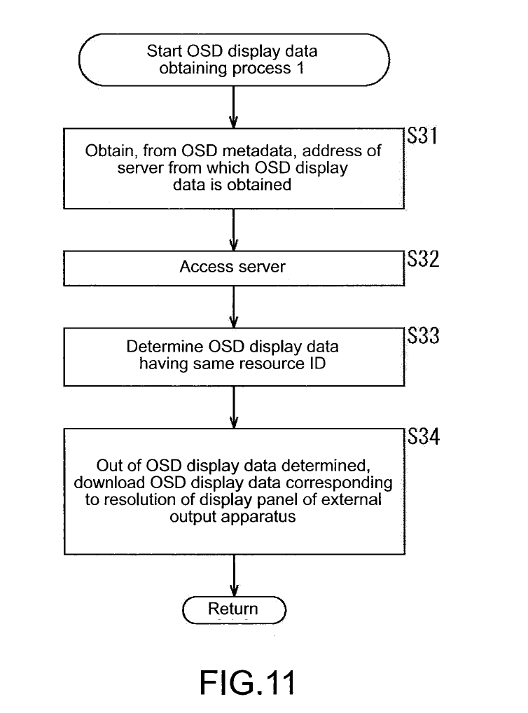

Next, with reference to a flowchart of FIG. 11, the OSD display data obtaining process 1 performed in Step S15 of FIG. 10 will be described. The OSD display data obtaining process 1 is a process of obtaining the OSD display data from the management server 5.

In Step S31, the OSD display data obtaining unit 111 obtains, from the OSD metadata, an address of a server from which the OSD display data to be used to display the OSD information on which attention is focused is obtained.

In Step S32, the OSD display data obtaining unit 111 controls the network communication unit 101 and accesses the server on the basis of the address obtained from the OSD metadata. Here, the management server 5 is specified as an obtaining source. The access to the management server 5 is performed.

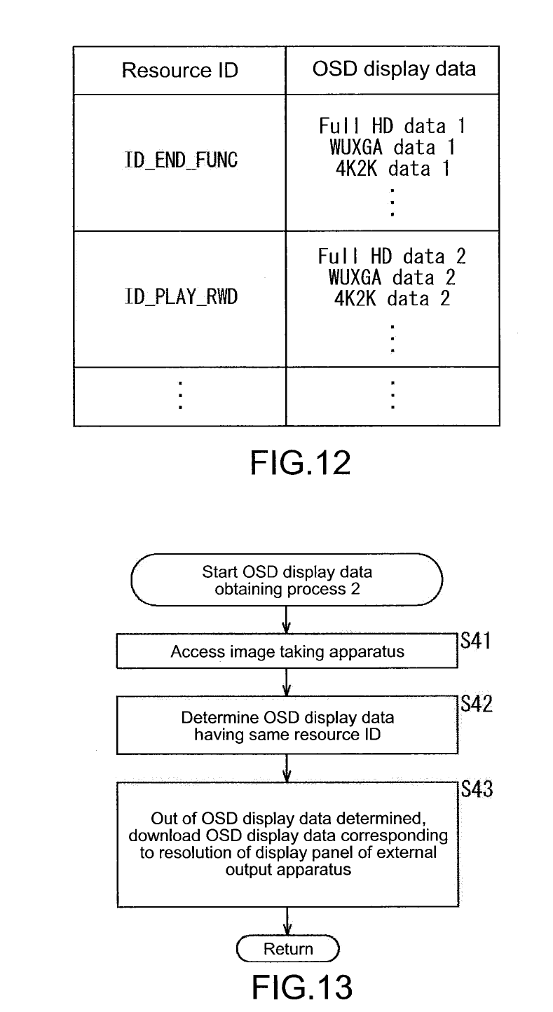

FIG. 12 is a diagram showing an example of the OSD display data managed by the management server 5.

As shown in FIG. 12, in the management server 5, the OSD display data to be used to display the OSD information of each resolution is managed with the OSD display data associated with the resource IDs of the pieces of OSD information.

In the example shown in FIG. 12, as the OSD display data of the OSD information having the resource ID of “ID_END_FUNC”, Full HD data 1, WUXGA data 1, and 4K2K data 1 are managed. As the OSD display data of the OSD information having the resource ID of “ID_PLAY_RWD”, Full HD data 2, WUXGA data 2, and 4K2K data 2 are managed.

The Full HD data 1 and the Full HD data 2 are used when the OSD information is displayed on a display panel having a Full HD resolution. The WUXGA data 1 and the WUXGA data 2 are used when the OSD information is displayed on a display panel having a WUXGA resolution. The 4K2K data 1 and the 4K2K data 2 are used when the OSD information is displayed on the display panel having a 4K2K resolution.

For example, the WUXGA data 1 is data used when a button of the same type as the function end button 31 shown in FIG. 2 is displayed with more pixels, that is, with a higher resolution than the Full HD data 1. Further, 4K2K data 1 is data used when a button of the same type as the function end button 31 is displayed with more pixels than the WUSGA data 1.

As described above, in the management server 5, the pieces of OSD display data are associated with the resource IDs respectively, with the result that it is possible to determine which type of the OSD information the OSD display data is used to display.

Returning to the explanation of FIG. 11, in Step S33, the OSD display data obtaining unit 111 determines the OSD display data associated with the resource ID that coincides with the resource ID of the OSD information on which attention is focused, from among the pieces of OSD display data managed by the management server 5.

In Step S34, the OSD display data obtaining unit 111 controls the network communication unit 101 to download and obtain the OSD display data that corresponds to the resolution of the display panel 98, out of the OSD display data determined.

For example, in the case where the OSD information of OSD_ID=1 shown in FIG. 8 receives attention, on the basis of the resource ID of “ID_END_FUNC”, the Full HD data 1, the WUXGA data 1, and the 4K2K data 1 as the OSD display data having the resource ID that coincides therewith are discriminated. When the resolution of the display panel 98 is the Full HD resolution, the Full HD data 1 is downloaded out of the Full HD data 1, the WUXGA data 1, and the 4K2K data 1.

After the OSD display data is downloaded, the process returns to Step S15 in FIG. 10, and the subsequent process is performed. The OSD display data obtained is supplied to the display control unit 112 and used to display the OSD information (Step S18).

Through the above process, on the basis of the OSD display data obtained from the management server 5, the OSD information corresponding to the resolution of the display panel 98 of the external output apparatus 2 can be displayed, with the result that the OSD information having a high image quality can be displayed.

The pieces of OSD display data having different impressions may be managed for each server as the OSD display data to be used to display the OSD information of the same type. For example, a server manages the OSD display data to be used to display pop OSD information, and another server manages the OSD display data to be used to display classic OSD information. On the basis of the address included in the OSD metadata, by setting an access destination to be switchable, it is possible to increase variations of the OSD information to be displayed.

(OSD Display Data Obtaining Process 2)

Next, with reference to a flowchart shown in FIG. 13, the OSD display data obtaining process 2 to be performed in Step S16 of FIG. 10 will be described. The OSD display data obtaining process 2 is a process of obtaining the OSD display data from the image taking apparatus 1.

In Step S41, the OSD display data obtaining unit 111 controls the apparatus communication unit 100 to access the image taking apparatus 1. In the image taking apparatus 1, as described with reference to FIG. 12, the OSD display data to be used to display the OSD information having different resolutions is stored in the memory 57 or the like with the data associated with the resource IDs.

In Step S42, from among the OSD display data managed by the image taking apparatus 1, the OSD display data obtaining unit 111 determines the OSD display data associated with the resource ID that coincides with the resource ID of the OSD information on which attention is focused.

In Step S43, the OSD display data obtaining unit 111 controls the apparatus communication unit 100 to download and obtain the OSD display data that corresponds to the resolution of the display panel 98 from among the determined OSD display data. A request for transmission of the OSD display data that corresponds to the resolution of the display panel 98 is issued to the image taking apparatus 1. In response to the request, the OSD display data transmitted from the image taking apparatus 1 is obtained by the OSD display data obtaining unit 111.

After the OSD display data is downloaded, the process returns to Step S16 of FIG. 10, and a subsequent process is performed. The obtained OSD display data is supplied to the display control unit 112 and used to display the OSD information (Step S18).

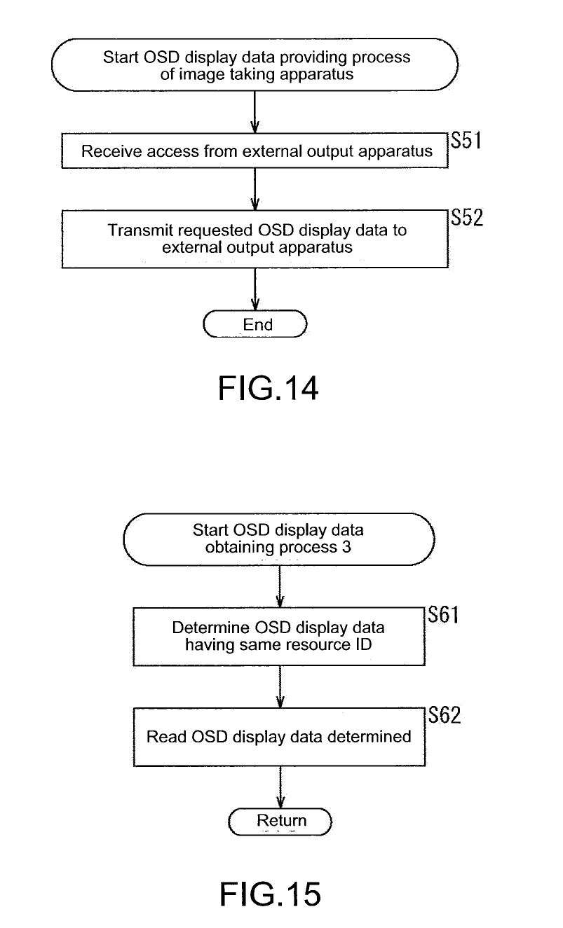

Here, with reference to the flowchart shown in FIG. 14, the process of the image taking apparatus 1 which is performed so as to correspond to the process of FIG. 13 will be described.

In Step S51, the OSD information management unit 71 of the image taking apparatus 1 receives a transmission request of the OSD display data that corresponds to the resolution of the display panel 98, which is transmitted from the image taking apparatus 1 in reaction to an access by the image taking apparatus 1 by controlling the apparatus communication unit 58.

In Step S52, the OSD information management unit 71 reads the requested OSD display data from the memory 57 and transmits the data to the external output apparatus 2. Then, the process is terminated.

Through the above process, it is possible to display the OSD information corresponding to the resolution of the display panel 98 of the external output apparatus 2 on the basis of the OSD display data obtained from the image taking apparatus 1, with the result that the OSD information having a higher image quality can be displayed.

(OSD Display Data Obtaining Process 3)

Next, with reference to the flowchart of FIG. 15, the OSD display data obtaining process 3 performed in Step S17 of FIG. 10 will be described. The OSD display data obtaining process 3 is a process of obtaining the OSD display data from the memory 99 of the external output apparatus 2.

In Step S61, the OSD display data obtaining unit 111 determines the OSD display data associated with the resource ID that coincides with the resource ID of the OSD information on which attention is focused, from among the OSD display data recorded in the memory 99.

In the memory 99 of the external output apparatus 2, the OSD display data to be used to display the OSD information corresponding to the resolutions of the display panel 98 is recorded with the data associated with the resource IDs. A description will be given with reference to FIG. 12 assuming that the resolution of the display panel 98 is the Full HD resolution. In the memory 99, the Full HD data 1 is recorded with the data associated with the resource ID of “ID_END_FUNC”. Further, the Full HD data 2 is recorded with the data associated with the resource ID of “ID_PLAY_RWD”.

In Step S62, the OSD display data obtaining unit 111 reads and obtains the determined OSD display data from the memory 99. For example, in the case where the OSD information of OSD_ID=1 shown in FIG. 8 receives attention, the Full HD data 1 associated with the resource ID of “ID_END_FUNC” is obtained out of the OSD display data recorded in the memory 99.

After the OSD display data is obtained, the process returns to Step S17 of FIG. 10, a subsequent process is performed. The obtained OSD display data is supplied to the display control unit 112 and used to display the OSD information (Step S18).

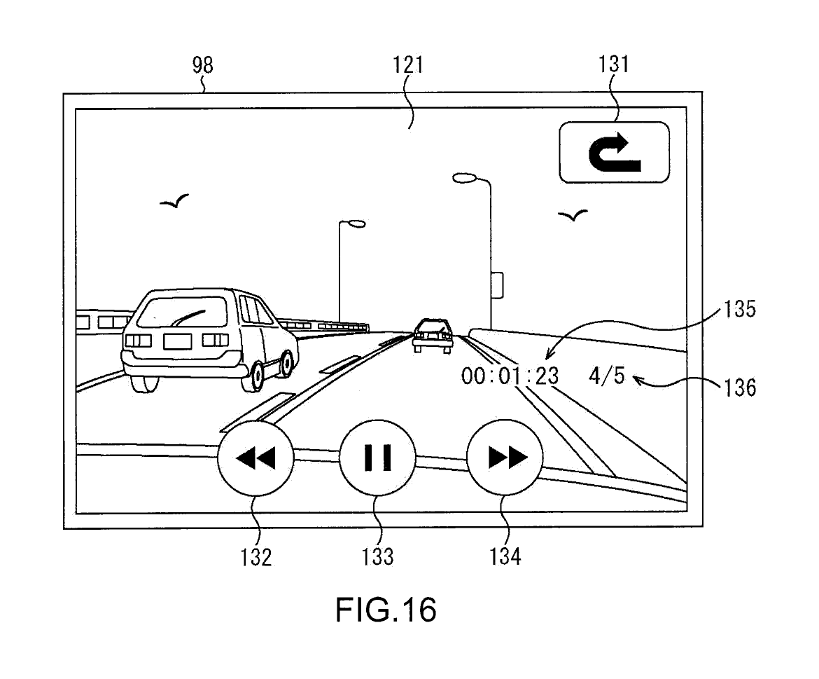

FIG. 16 is a diagram showing an example of the OSD information displayed on the display panel 98 of the external output apparatus 2 after the process shown in FIG. 15 is performed. After the processes shown in FIGS. 13 and 14, the same OSD information is also displayed on the display panel 98.

A screen shown in FIG. 16 is a screen displayed with the use of the OSD metadata shown in FIG. 8 which is generated by the image taking apparatus 1 when the screen shown in FIG. 2 is displayed.

On an entire screen of the display panel 98, a taken image content display area 121 is provided. On the area, the taken image content transmitted from the image taking apparatus 1 is displayed. The various pieces of OSD information are displayed on the basis of the OSD metadata so as to be overlapped with the taken image content displayed on the taken image content display area 121. The OSD information shown in FIG. 16 is OSD information having higher resolution than the OSD information shown in FIG. 2.

On a position represented by coordinates (0.78, 0.07) on an upper right portion of the screen, a function end button 131 is displayed so as to have a size represented by a size (0.12, 0.107). The function end button 131 is a button operated when reproduction of the taken image content is ended like the function end button 31 shown in FIG. 2.

In the example of FIG. 16, the picture of the function end button 131 is different from that of the function end button 31. This shows that the OSD display data prepared in the external output apparatus 2 in the state of being associated with the resource ID of “ID_END_FUNC” is different from the OSD display data of the function end button 31 prepared in the image taking apparatus 1 in terms of not only the resolution but also the picture.

The button which is generally used to end the function in the external output apparatus 2 is also used to display the taken image content from the image taking apparatus 1 and displayed in place of the function end button 31, with the result that it is possible to obtain consistency of the operation. In the case where the button, the picture of which is different from the button used to end the function provided at a time of a normal operation of the external output apparatus 2, is displayed as the function end button 131, the operation of ending the function is performed by using the buttons having pictures different depending on the functions. This makes an intuitive operation difficult. Such a case can be prevented.

On the position represented by coordinates (0.24, 0.76) on a lower portion of the screen, a reproduction operation button 132 is displayed so as to have a size represented by a size (0.075, 0.134). The reproduction operation button 132 is a button used to a fast-rewind operation to return to a preceding taken image content, like the reproduction operation button 32 shown in FIG. 2.

Reproduction operation buttons 133 and 134, a reproduction time information 135, and a file number information 136 are also displayed so as to be overlapped with the taken image content on the basis of the OSD metadata as shown in FIG. 16.

Through the above process, on the basis of the OSD display data prepared in the external output apparatus 2, it is possible to display the OSD information having a high image quality corresponding to the resolution of the display panel 98 of the external output apparatus 2.

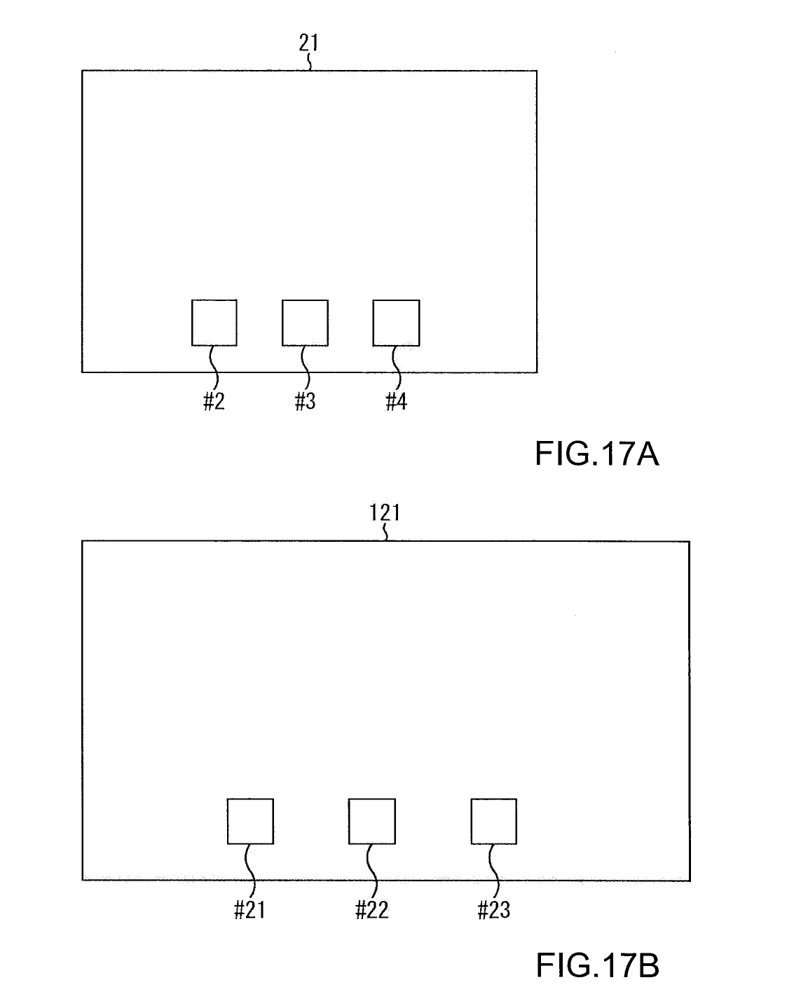

FIGS. 17A and 17B are diagrams for explaining sizes of rectangular areas in which the OSD information is displayed.

A description will be given for the case where the reproduction operation buttons 32, 33, and 34 are displayed on the external output apparatus 2. FIG. 17A shows a taken image content display area 21 of the display panel 11 having the aspect ratio of 3:2 which is held by the image taking apparatus 1. FIG. 17B shows a taken image content display area 121 of the display panel 98 having the aspect ratio of 16:9 which is held by the external output apparatus 2.

On the display panel 11, the reproduction operation buttons 32, 33, and 34 displayed in areas #2, #3, and #4 (FIG. 17A), respectively, each having a size (0.1, 0.15) are displayed in areas #21, #22, and #23, respectively, on the display panel 98 on the basis of a size (0.075, 0.134) corresponding to the aspect ratio of 16:9 with the aspect ratio maintained as shown in FIG. 17B.

In this way, by preparing the information relating to the size of the OSD information for each aspect ratio of the display panel on which the information is to be displayed, it is possible to prevent the OSD information having a distorted aspect ratio from being displayed.

### Modified Example

### Modified Example of OSD Metadata

Instead of including the information relating to the size for each aspect ratio of the display panel in the OSD metadata, the information relating to the aspect ratio of the display panel 11 of the image taking apparatus 1 may be included in the OSD metadata, and the external output apparatus 2 may be notified of the metadata, to adjust the size of the OSD information so as to correspond to the aspect ratio of the display panel 98.

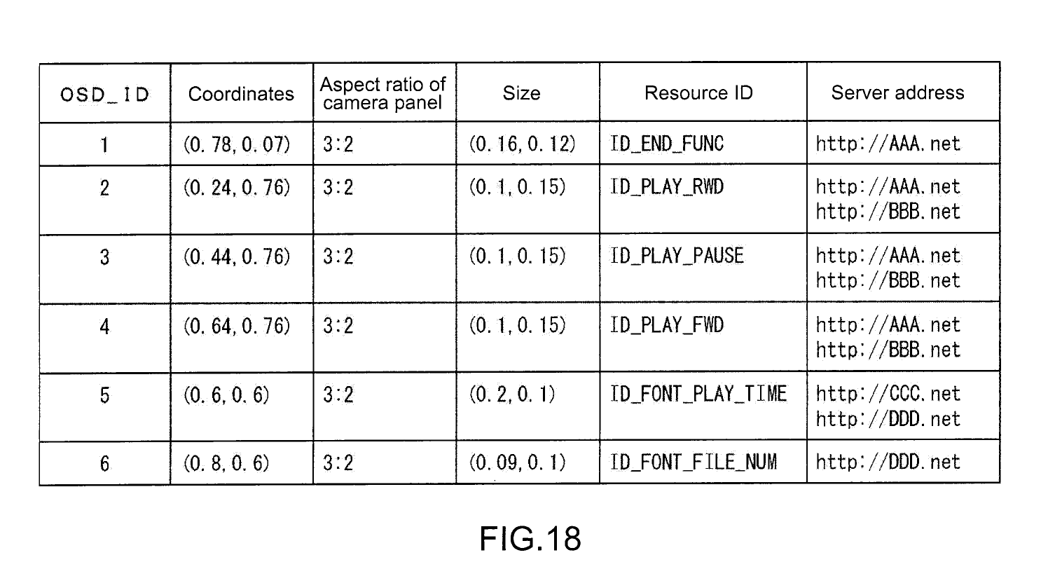

FIG. 18 is a diagram showing other specific examples of the OSD metadata.

In the example of FIG. 18, information indicating that the aspect ratio (aspect ratio of the display panel 11 of the image taking apparatus 1) of a camera panel is 3:2 is included for each piece of OSD information. In addition, the OSD metadata shown in FIG. 18 includes, as the information relating to the size, information indicating the size on the display panel 11 having the aspect ratio of 3:2.

In the case where the OSD information is displayed by using the OSD metadata as described above, the display control unit 112 of the external output apparatus 2 adjusts the OSD information having the size expressed by the size included in the OSD metadata to a size corresponding to the aspect ratio of the display panel 98 and displays the information. As a result, as in the case where the information relating to the size for each aspect ratio is included, it is possible to display the OSD information on the external output apparatus 2 with the aspect ratio maintained.

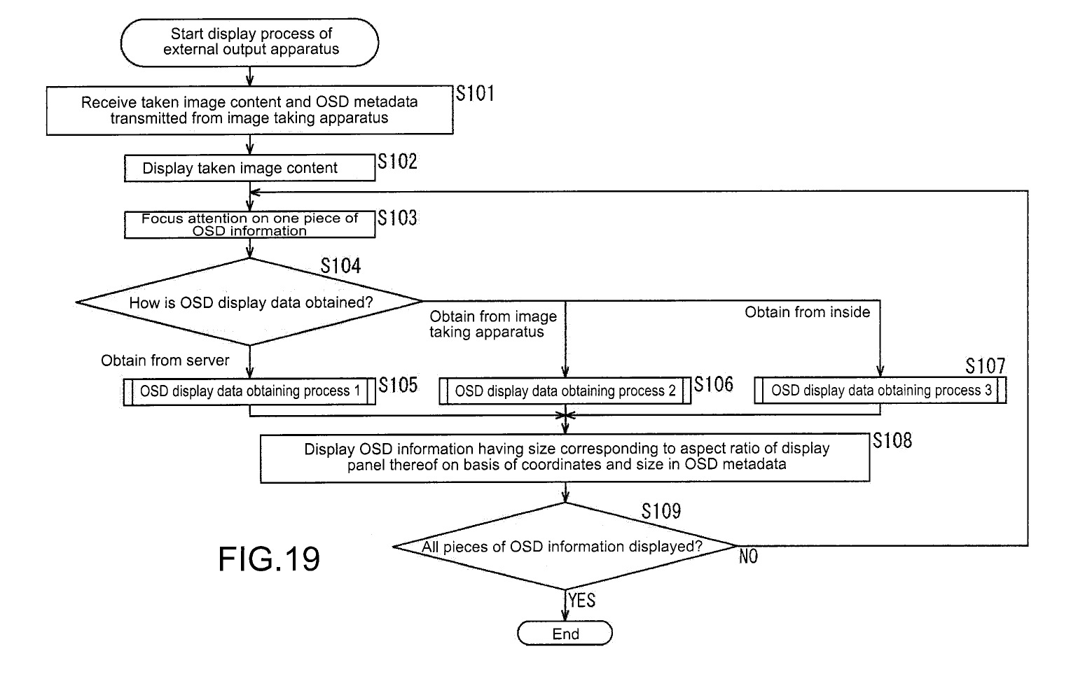

Here, with reference to a flowchart shown in FIG. 19, a process of the external output apparatus 2 that displays the OSD information on the basis of the OSD metadata shown in FIG. 18 will be described. The process shown in FIG. 19 is basically equal to the process described with reference to FIG. 10. For an overlapping part, the explanation will be omitted as appropriate.

In Step S101, the apparatus communication unit 100 receives the taken image content and the OSD metadata which are transmitted from the image taking apparatus 1.

In Step S102, the display control unit 112 causes the taken image content to be displayed on the display panel 98.

In Step S103, the OSD display data obtaining unit 111 focuses attention on one piece of OSD information and determines the method of obtaining the OSD display data in Step S104.

In Steps S105, S106, and S107, the OSD display data obtaining unit 111 obtains the OSD display data by the OSD display data obtaining processes 1, 2, and 3, respectively.

In Step S108, the display control unit 112 causes the OSD information on which attention is focused to be displayed with the size corresponding to the aspect ratio of the display panel 98 on the basis of the coordinates and the size included in the OSD metadata. That is, the display control unit 112 adjusts the OSD information having the size included in the OSD metadata so as to have the size corresponding to the aspect ratio of the display panel 98, thereby causing the information to be displayed on the position on the display panel 98 specified by the coordinates included in the OSD metadata with the information overlapped with the taken image content.

In Step S109, the display control unit 112 determines whether all the pieces of OSD information specified are displayed or not. When the display control unit 112 determines that displaying of all the pieces of OSD information is terminated, the display control unit 112 terminates the process.

(About OSD Information Associated with Update)

Out of the pieces of OSD information, the reproduction time information 35 and the file number information 36 shown in FIG. 2 are information updated at predetermined timings. The reproduction time information 35 is updated as time passes after the taken image content is started to be displayed. The file number information 36 is updated along with switching of the taken image content.

For example, the update of the OSD information is implemented by transmitting the OSD metadata from the image taking apparatus 1 to the external output apparatus 2 for each update timing and displaying the OSD information by the external output apparatus 2 on the basis of the OSD metadata transmitted from the image taking apparatus 1.

Further, the external output apparatus 2 may obtain the pieces of image data of 0 to 9, which are used to display the OSD information involving the update, on the basis of the OSD metadata transmitted from the image taking apparatus 1, and the display and update of the OSD information may be performed in combination with the image data obtained. The way of combining the numerical image data is specified by the OSD metadata with respect to the external output apparatus 2 from the image taking apparatus 1, for example.

(Others)

In the above, the process in the case where the OSD information is displayed is described. The process described above can be applied to various systems that cause an image generated by a certain apparatus to be displayed on a display of an external apparatus. For example, it is also possible to apply the process to a system that causes a menu screen of a mobile terminal on which various icons are arranged to be displayed on a TV.

(About Program)

The series of processes described above can be executed by hardware or software. When the series of processes are executed by software, a program that configures the software is installed from a program recording medium to a computer incorporated in dedicated hardware, a general-purpose personal computer, or the like.

The program to be installed is provided by being recorded in a removable medium 103 shown in FIG. 5, such as an optical disk and a semiconductor memory. The program may be provided via a wired or wireless transmission medium such as a local area network, the Internet, and digital broadcast. The program can be installed in the ROM 92 or the memory 99 in advance.

It should be noted that the program executed by a computer may be a program the processes of which are executed chronologically in order of the description in the specification or may be a program the processes of which are executed in parallel or at a necessary timing, for example, at a time of being called.

It should be noted that in the specification, the system means a set of the plurality of components (apparatus, module (part), and the like). Whether all the components are provided in the same casing or not is not limited. Therefore, a plurality of apparatuses which are stored in separate casings and connected to each other via a network and one apparatus in which a plurality of modules are stored in one casing are both systems.

The present disclosure is not limited to the above embodiment and can be variously modified without departing from the gist of the present disclosure.

For example, the steps in the flowcharts described above can be executed by one apparatus or by a plurality of apparatuses. Further, in the case where one step includes a plurality of processes, the plurality of processes in the one step can be performed by one apparatus or by a plurality of apparatuses.

(Combination Example of Structures)

It should be noted that the present disclosure can take the following configurations.

(1) An information processing apparatus, including:

a generation unit configured to generate attribute information of OSD information which is displayed with the OSD information overlapped with an image, the attribute information including at least information relating to a display position and a display size of the OSD information; and

a transmission unit configured to transmit the attribute information to an output apparatus that obtains display data to be used to display the OSD information corresponding to a resolution of a display unit thereof and causes the OSD information to be displayed on a position on the display unit specified by the information relating to the display position in a size specified by the information relating to the display size on the basis of the display data.

(2) The information processing apparatus according to Item (1), further including

an image taking unit configured to take the image, in which

the transmission unit transmits the image taken by the image taking unit and transmits the attribute information of the OSD information to be displayed with the OSD information overlapped with the image transmitted.

(3) The information processing apparatus according to Item (1) or (2), in which

the generation unit generates the attribute information further including an address of a server that manages a plurality of pieces of display data to be used to display the OSD information at different resolutions as the display data of the OSD information of the same type.

(4) The information processing apparatus according to any one of Items (1) to (3), further including

a storage unit configured to store a plurality of pieces of display data to be used to display the OSD information at different resolutions as the display data of the OSD information of the same type, in which

the transmission unit transmits the display data to be used to display the OSD information corresponding to the resolution of the display unit of the output apparatus to the output apparatus.

(5) The information processing apparatus according to any one of Items (1) to (4), in which

the generation unit generates the attribute information further including identification information that indicates a type of the OSD information.

(6) An information processing method, including:

generating attribute information of OSD information which is displayed with the OSD information overlapped with an image, the attribute information including at least information relating to a display position and a display size of the OSD information; and

transmitting the attribute information to an output apparatus that obtains display data to be used to display the OSD information corresponding to a resolution of a display unit thereof and causes the OSD information to be displayed on a position on the display unit specified by the information relating to the display position in a size specified by the information relating to the display size on the basis of the display data.

(7) A program causing a computer to execute a process including

generating attribute information of OSD information which is displayed with the OSD information overlapped with an image, the attribute information including at least information relating to a display position and a display size of the OSD information, and

transmitting the attribute information to an output apparatus that obtains display data to be used to display the OSD information corresponding to a resolution of a display unit thereof and causes the OSD information to be displayed on a position on the display unit specified by the information relating to the display position in a size specified by the information relating to the display size on the basis of the display data.

(8) An output apparatus, including:

a display unit configured to display an image;

a reception unit configured to receive attribute information of OSD information which is transmitted from an information processing apparatus that generates the attribute information, the OSD information being displayed with the OSD information overlapped with the image, the attribute information including at least information relating to a display position and a display size of the OSD information;

an obtaining unit configured to obtain display data to be used to display the OSD information corresponding to a resolution of the display unit; and

a display control unit configured to cause the OSD information to be displayed on a position on the display unit specified by the information relating to the display position in a size specified by the information relating to the display size on the basis of the display data.

(9) The output apparatus according to Item (8), in which

the reception unit receives the image, which is taken by the information processing apparatus and transmitted from the information processing apparatus, and receives the attribute information of the OSD information to be displayed with the OSD information overlapped with the image received.

(10) The output apparatus according to Item (8) or (9), in which

the reception unit receives the attribute information further including an address of a server that manages a plurality of pieces of display data to be used to display the OSD information at different resolutions as the display data of the OSD information of the same type, and

the obtaining unit accesses the server on the basis of the address and obtains the display data to be used to display the OSD information corresponding to the resolution of the display unit.

(11) The output apparatus according to any one of Items (8) to (10), in which

the obtaining unit obtains, as the display data of the OSD information of the same kind, the display data to be used to display the OSD information corresponding to the resolution of the display unit from the information processing apparatus that manages a plurality of pieces of display data to be used to display the OSD information at different resolutions.

(12) The output apparatus according to any one of Items (8) to (11), further including

a storage unit configured to store the display data to be used to display the OSD information corresponding to the resolution of the display unit, in which

the reception unit receives the attribute information further including identification information that indicates a type of the OSD information, and

the obtaining unit obtains the display data to be used to display the OSD information of the same type as a type indicated by the identification information from the storage unit.

(13) An output method, including:

receiving attribute information of OSD information which is transmitted from an information processing apparatus that generates the attribute information, the OSD information being displayed with the OSD information overlapped with an image, the attribute information including at least information relating to a display position and a display size of the OSD information;

obtaining display data to be used to display the OSD information corresponding to a resolution of the display unit that displays the image; and

causing the OSD information to be displayed on a position on the display unit specified by the information relating to the display position in a size specified by the information relating to the display size on the basis of the display data.

(14) A program causing a computer to execute a process including

receiving attribute information of OSD information which is transmitted from an information processing apparatus that generates the attribute information, the OSD information being displayed with the OSD information overlapped with an image, the attribute information including at least information relating to a display position and a display size of the OSD information,

obtaining display data to be used to display the OSD information corresponding to a resolution of the display unit that displays the image, and

causing the OSD information to be displayed on a position on the display unit specified by the information relating to the display position in a size specified by the information relating to the display size on the basis of the display data.

(15) An information processing system, including:

an information processing apparatus including
a generation unit configured to generate attribute information of OSD information displayed with the OSD information overlapped with an image, the attribute information including at least information relating to a display position and a display size of the OSD information, and
a transmission unit configured to transmit the attribute information to an output apparatus; and

the output apparatus including
a display unit configured to display the image,
a reception unit configured to receive the attribute information,
an obtaining unit configured to obtain display data to be used to display the OSD information corresponding to a resolution of the display unit, and
a display control unit configured to cause the OSD information to be displayed on a position on the display unit specified by the information relating to the display position in a size specified by the information relating to the display size on the basis of the display data.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a generation unit configured to generate attribute information of OSD information which is displayed with the OSD information overlapped with an image, the attribute information including at least information relating to a display position and a display size of the OSD information; and
a transmission unit configured to transmit the attribute information to an output apparatus that obtains display data to be used to display the OSD information corresponding to a resolution of a display unit thereof and causes the OSD information to be displayed on a position on the display unit specified by the information relating to the display position in a size specified by the information relating to the display size on the basis of the display data.

2. The information processing apparatus according to claim 1, further comprising
an image taking unit configured to take the image, wherein
the transmission unit transmits the image taken by the image taking unit and transmits the attribute information of the OSD information to be displayed with the OSD information overlapped with the image transmitted.

3. The information processing apparatus according to claim 1, wherein
the generation unit generates the attribute information further including an address of a server that manages a plurality of pieces of display data to be used to display the OSD information at different resolutions as the display data of the OSD information of the same type.

4. The information processing apparatus according to claim 1, further comprising
a storage unit configured to store a plurality of pieces of display data to be used to display the OSD information at different resolutions as the display data of the OSD information of the same type, wherein
the transmission unit transmits the display data to be used to display the OSD information corresponding to the resolution of the display unit of the output apparatus to the output apparatus.

5. The information processing apparatus according to claim 1, wherein
the generation unit generates the attribute information further including identification information that indicates a type of the OSD information.

6. An information processing method, comprising:
generating attribute information of OSD information which is displayed with the OSD information overlapped with an image, the attribute information including at least information relating to a display position and a display size of the OSD information; and
transmitting the attribute information to an output apparatus that obtains display data to be used to display the OSD information corresponding to a resolution of a display unit thereof and causes the OSD information to be displayed on a position on the display unit specified by the information relating to the display position in a size specified by the information relating to the display size on the basis of the display data.

7. A program causing a computer to execute a process including
generating attribute information of OSD information which is displayed with the OSD information overlapped with an image, the attribute information including at least information relating to a display position and a display size of the OSD information, and
transmitting the attribute information to an output apparatus that obtains display data to be used to display the OSD information corresponding to a resolution of a display unit thereof and causes the OSD information to be displayed on a position on the display unit specified by the information relating to the display position in a size specified by the information relating to the display size on the basis of the display data.

8. An output apparatus, comprising:
a display unit configured to display an image;
a reception unit configured to receive attribute information of OSD information which is transmitted from an information processing apparatus that generates the attribute information, the OSD information being displayed with the OSD information overlapped with the image, the attribute information including at least information relating to a display position and a display size of the OSD information;
an obtaining unit configured to obtain display data to be used to display the OSD information corresponding to a resolution of the display unit; and
a display control unit configured to cause the OSD information to be displayed on a position on the display unit specified by the information relating to the display position in a size specified by the information relating to the display size on the basis of the display data.

9. The output apparatus according to claim 8, wherein
the reception unit receives the image, which is taken by the information processing apparatus and transmitted from the information processing apparatus, and receives the attribute information of the OSD information to be displayed with the OSD information overlapped with the image received.

10. The output apparatus according to claim 8, wherein
the reception unit receives the attribute information further including an address of a server that manages a plurality of pieces of display data to be used to display the OSD information at different resolutions as the display data of the OSD information of the same type, and
the obtaining unit accesses the server on the basis of the address and obtains the display data to be used to display the OSD information corresponding to the resolution of the display unit.

11. The output apparatus according to claim 8, wherein
the obtaining unit obtains, as the display data of the OSD information of the same kind, the display data to be used to display the OSD information corresponding to the resolution of the display unit from the information processing apparatus that manages a plurality of pieces of display data to be used to display the OSD information at different resolutions.

12. The output apparatus according to claim 8, further comprising
a storage unit configured to store the display data to be used to display the OSD information corresponding to the resolution of the display unit, wherein
the reception unit receives the attribute information further including identification information that indicates a type of the OSD information, and
the obtaining unit obtains the display data to be used to display the OSD information of the same type as a type indicated by the identification information from the storage unit.

13. An output method, comprising:
receiving attribute information of OSD information which is transmitted from an information processing apparatus that generates the attribute information, the OSD information being displayed with the OSD information overlapped with an image, the attribute information including at least information relating to a display position and a display size of the OSD information;
obtaining display data to be used to display the OSD information corresponding to a resolution of the display unit that displays the image; and
causing the OSD information to be displayed on a position on the display unit specified by the information relating to the display position in a size specified by the information relating to the display size on the basis of the display data.

14. A program causing a computer to execute a process including
receiving attribute information of OSD information which is transmitted from an information processing apparatus that generates the attribute information, the OSD information being displayed with the OSD information overlapped with an image, the attribute information including at least information relating to a display position and a display size of the OSD information,
obtaining display data to be used to display the OSD information corresponding to a resolution of the display unit that displays the image, and
causing the OSD information to be displayed on a position on the display unit specified by the information relating to the display position in a size specified by the information relating to the display size on the basis of the display data.

15. An information processing system, comprising:
an information processing apparatus including
a generation unit configured to generate attribute information of OSD information displayed with the OSD information overlapped with an image, the attribute information including at least information relating to a display position and a display size of the OSD information, and
a transmission unit configured to transmit the attribute information to an output apparatus; and
the output apparatus including
a display unit configured to display the image,
a reception unit configured to receive the attribute information,
an obtaining unit configured to obtain display data to be used to display the OSD information corresponding to a resolution of the display unit, and
a display control unit configured to cause the OSD information to be displayed on a position on the display unit specified by the information relating to the display position in a size specified by the information relating to the display size on the basis of the display data.
